(19) United States
(12) Patent Application Publication
(10) Pub. No.: US 2024/0332997 A1
(43) Pub. Date: Oct. 3, 2024

(54) BATTERY MANAGEMENT DEVICE FOR BATTERY HAVING VOLTAGE PLATEAU SECTION, AND METHOD FOR CONTROLLING SAME

(71) Applicant: LG ENERGY SOLUTION, LTD., Seoul (KR)

(72) Inventors: Jeong Seok PARK, Daejeon (KR); Youngdoo SONG, Daejeon (KR); Yunseong HWANG, Daejeon (KR)

(73) Assignee: LG ENERGY SOLUTION, LTD., Seoul (KR)

(21) Appl. No.: 18/738,629

(22) Filed: Jun. 10, 2024

Related U.S. Application Data
(63) Continuation of application No. PCT/KR2023/009140, filed on Jun. 29, 2023.

(30) Foreign Application Priority Data
Sep. 27, 2022 (KR) 10-2022-0122260
Jan. 17, 2023 (KR) 10-2023-0006698

(51) Int. Cl. H02J 7/00; H01M 4/02; H01M 4/58; H01M 10/42

(52) U.S. Cl. CPC H02J 7/0031; H01M 4/5825; H01M 10/425; H02J 7/0013; H02J 7/0048; H01M 2004/028; H01M 2010/4271

(57) ABSTRACT

A battery management apparatus for managing and controlling a battery connected in parallel with one or more other batteries can include at least one processor; and a memory for storing at least one instruction executed by the at least one processor. The at least one instruction includes an instruction to diagnose whether or not the battery is abnormal based on the state information of the battery, and an instruction to, upon the battery determined to be in an abnormal state, control whether to release the parallel connection between the battery and the one or more other batteries based on whether a state of charge (SOC) of the battery is within a threshold SOC range, the threshold SOC range being predefined as SOC estimation impossible section.

### CROSS REFERENCE TO RELATED APPLICATIONS

This application is a Continuation of PCT International Application No. PCT/KR2023/009140, filed on Jun. 29, 2023, which claims the priority benefit of Korean Patent Application No. 10-2022-0122260 filed in the Republic of Korea on Sep. 27, 2022 and Korean Patent Application No. 10-2023-0006698 filed in the Republic of Korea on Jan. 17, 2023, the entire contents of all of which are incorporated herein by reference into the present application.

### BACKGROUND OF THE INVENTION

### 1. Field of the Invention

The present invention relates to a battery management apparatus and an operating method thereof, and more particularly, to a battery management apparatus for a stable operation of a battery system including a battery having a voltage plateau (e.g., voltage plateau section) and an operating method thereof.

### 2. Description of the Related Art

A secondary battery is a type of battery that can be recharged and reused (e.g., a plurality of times or cycles) even after being discharged. The secondary battery can be used as an energy source for small devices, such as mobile phones, tablet PCs and vacuum cleaners, and also used as an energy source for medium and large devices such as an energy storage system (ESS) for automobiles and smart grids.

The secondary battery can be applied to a system in a form of an assembly, such as a battery module in which a plurality of battery cells are connected in series or in parallel or a battery pack in which battery modules are connected in series or in parallel, according to system requirements.

Carbon materials are mainly used as an anode active material of lithium secondary batteries (e.g., lithium-based or lithium-containing secondary batteries), whereas lithium-containing cobalt oxide (LiCoO2) is mainly used as a cathode active material, and lithium-containing manganese oxides (LiMnO2, LiMn2O4, etc.) and lithium-containing nickel oxide (LiNiO2) are also being considered for secondary batteries.

Recently, a lithium iron phosphate (LiFePO4)-based (e.g., LiFePO4-comtaining) compound has been used as a cathode active material for a lithium secondary battery. A lithium iron phosphate (LFP) battery, which uses lithium iron phosphate as a cathode active material, is superior in compared to other battery types in terms of thermal stability and cost efficiency. However, the LFP battery exhibits a plateau characteristic (e.g., a voltage plateau section) in a charging characteristic curve (e.g., correlation curve between open circuit voltage (OCV) and state of charge (SOC)). It is difficult to accurately estimate the state of charge (SOC) of the LFP battery in this voltage plateau section because generally (e.g., with other battery types) a change in voltage is used to estimate the SOC of the battery.

During operation of a battery system including battery assemblies connected in parallel, if an abnormality occurs in a specific battery assembly (e.g., in a specific battery), the specific battery assembly is disconnected from the battery system (e.g., parallel connection released) and the specific battery assembly can be reconnected to the battery system when the abnormality is resolved (e.g., fixed or the specific battery assembly is replaced with another battery assembly). Here, the specific battery assembly can be reconnected to the battery system if the SOC of the specific battery assembly is the same as or very similar to those of other battery assemblies.

However, in the case of a battery system to which an LFP battery is applied (that is, a battery system including LFP-based or LFP-containing battery assemblies), if an abnormality occurs in a specific battery assembly in the voltage plateau section, the battery assembly needs to be fully charged or fully discharged in order to be reconnected to the battery system after the battery assembly is disconnected from the battery system. This is because the SOC of the LFP battery cannot be accurately estimated in the voltage plateau section. Accordingly, a problem arises in that a considerable amount of time is required until the specific battery assembly is reconnected to the battery system because it must first be fully charged or fully discharged.

### SUMMARY OF THE DISCLOSURE

To obviate one or more problems of the related art, aspects of the present disclosure provide a battery management apparatus for a stable operation of a battery system including a battery having a voltage plateau.

To obviate one or more problems of the related art, aspects of the present disclosure also provide a control method of the battery management apparatus.

To obviate one or more problems of the related art, aspects of the present disclosure also provide a battery system including the battery management apparatus.

In order to achieve the objective of the present disclosure, a battery management apparatus for managing and controlling a battery connected in parallel with one or more other batteries can include at least one processor, and a memory configured to store at least one instruction executed by the at least one processor.

Here, the at least one instruction include an instruction to diagnose whether or not the battery is abnormal based on the state information of the battery, and an instruction to, upon determining the battery to be in an abnormal state, control whether to release the parallel connection between the battery and the one or more other batteries based on whether a state of charge (SOC) of the battery is within a threshold SOC range, the threshold SOC range being is predefined as SOC estimation impossible section.

Here, the SOC estimation impossible section includes a voltage change relative to SOC change being equal to or less than a predefined threshold value, in a correlation curve depicting a relationship between the SOC and a voltage of the battery.

The instruction to control whether to release the parallel connection can include an instruction to release the parallel connection between the battery and the one or more other batteries when the SOC of the battery is outside of the threshold SOC range.

The instruction to control whether to release the parallel connection can include an instruction to, upon the SOC of the battery being within the threshold SOC range, control whether to release the parallel connection between the battery and the one or more other batteries according to whether a condition for maintaining the parallel connection is satisfied, wherein the condition for maintaining the parallel connection is predefined based on the state information of the battery.

The instruction to control whether to release the parallel connection can further include an instruction to maintain the parallel connection between the battery and the one or more other batteries in the instance that a first condition is satisfied, wherein the first condition is defined as a state in which a change amount of a cumulative current value of the battery is less than or equal to a predefined threshold value.

The instruction to control whether to release the parallel connection can further include an instruction to maintain the parallel connection between the battery and the one or more other batteries in the instance that a second condition is satisfied, wherein the second condition is defined as a state in which a state value including at least one of a temperature value of the battery, a current value of the battery, and a voltage value of the battery is equal to or less than a predefined threshold value, or defined as a state in which a change amount of the state value is equal to or less than a predefined threshold value.

The instruction to control whether to release the parallel connection can further include an instruction to release the parallel connection between the battery and the one or more other batteries when the condition for maintaining the parallel connection is not satisfied.

According to another aspect of the present disclosure, a control method, performed by a battery control apparatus that manages and controls a battery which is connected in parallel with one or more other batteries, can include diagnosing whether or not the battery is abnormal based on the state information of the battery, and upon determining the battery to be in an abnormal state, controlling whether to release the parallel connection between the battery and the one or more other batteries based on whether a state of charge (SOC) of the battery is within a threshold SOC range, the threshold SOC range being predefined as SOC estimation impossible section.

Here, the threshold SOC range can be predefined as a section of SOC in which a voltage change relative to SOC change is equal to or less than a predefined threshold value, in a correlation curve depicting a relationship between the SOC and a voltage of the battery.

The controlling whether to release the parallel connection can further include releasing the parallel connection between the battery and the one or more other batteries when the SOC of the battery is outside of the threshold SOC range.

The controlling whether to release the parallel connection can further include, upon the SOC of the battery being within the threshold SOC range, controlling whether to release the parallel connection between the battery and the one or more other batteries according to whether a condition for maintaining the parallel connection is satisfied, wherein the condition for maintaining the parallel connection is predefined based on the state information of the battery.

The controlling whether to release the parallel connection can further include maintaining the parallel connection between the battery and the one or more other batteries in the instance that a first condition is satisfied, wherein the first condition is defined as a state in which a change amount of a cumulative current value of the battery is less than or equal to a predefined threshold value.

The controlling whether to release the parallel connection can further include maintaining the parallel connection between the battery and the one or more other batteries in the instance that a second condition is satisfied, wherein the second condition is defined as a state in which a state value including at least one of a temperature value of the battery, a current value of the battery, and a voltage value of the battery is equal to or less than a predefined threshold value, or defined as a state in which a change amount of the state value is equal to or less than a predefined threshold value.

The controlling whether to release the parallel connection can further include releasing the parallel connection between the battery and the one or more other batteries when the condition for maintaining the parallel connection is not satisfied.

According to another aspect of the present disclosure, a battery system can include a plurality of batteries connected in parallel, and a plurality of battery management apparatus, each battery management apparatus being configured to manage and control a respective battery among the plurality of batteries. Here, each battery management apparatus can be configured to diagnose whether or not the respective battery is abnormal based on the state information of the respective battery and to control whether to release the parallel connection between the respective battery and one or more other batteries among the plurality of batteries based on whether a state of charge (SOC) of the respective battery is within a threshold SOC range, the threshold SOC range being predefined as SOC estimation impossible section.

Here, the threshold SOC range can be predefined as a section of SOC in which a voltage change relative to SOC change is equal to or less than a predefined threshold value, in a correlation curve depicting a relationship between the SOC and the voltage of the respective battery.

Each battery management apparatus is further configured to release the parallel connection between the respective battery and the one or more other batteries when the SOC of the respective battery is out of the threshold SOC range.

Each battery management apparatus can further be configured to, upon the SOC of the respective battery being within the threshold SOC range, control whether to release the parallel connection between the respective battery and the one or more other batteries according to whether a condition for maintaining the parallel connection is satisfied, wherein the condition for maintaining the parallel connection is predefined based on the state information of the respective battery.

Each battery management apparatus can further be configured to maintain the parallel connection between the respective battery and the one or more other batteries in the instance that a first condition is satisfied, wherein the first condition is defined as a state in which a change amount of a cumulative current value of the respective battery is less than or equal to a predefined threshold value.

The battery management apparatus can further be configured to maintain the parallel connection between the respective battery and the one or more other batteries in the instance that a second condition is satisfied, wherein the second condition is defined as a state in which a state value including at least one of a temperature value of the respective battery, a current value of the respective battery, and a voltage value of the respective battery is equal to or less than a predefined threshold value, or defined as a state in which a change amount of the state value is equal to or less than a predefined threshold value.

Each battery management apparatus can further be configured to release the parallel connection between the respective battery and the one or more other batteries when the condition for maintaining the parallel connection is not satisfied.

A battery system can include a battery including a cathode active material having lithium iron phosphate (LiFePO4), a battery management apparatus configured to manage and control the battery, and diagnose whether or not the battery is abnormal based on the state information of the battery, the state information of the battery including at least one of a voltage of the battery, a current of the battery, and a temperature of the battery, whether or not the battery is in a SOC estimation impossible section in which the battery exhibits an open circuit voltage (OCV) plateau section.

The battery of the battery system can comprise a battery module, a battery pack, a battery rack, or a battery bank.

### Advantageous Effects

According to aspects of the present disclosure, operational stability of the battery system can be improved by minimizing disconnection of an abnormal battery in the voltage plateau section.

Further scope of applicability of the invention will become apparent from the detailed description given hereinafter. However, it should be understood that the detailed description and specific examples, while indicating aspects of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a block diagram of a general energy storage system.

FIG. 2 shows a charging characteristic curve of the LFP battery.

FIG. 3 is a block diagram of a battery system according to aspects of the present invention.

FIG. 4 is an operation flowchart of a control method of the battery management apparatus according to an aspect of the present invention.

FIG. 5 is an operation flowchart of a control method of the battery management apparatus according to another aspect of the present invention.

FIG. 6 is a block diagram of a battery management apparatus according to aspects of the present invention.

### DETAILED DESCRIPTION OF THE EMBODIMENTS

The present invention will now be described with reference to the accompanying drawings, wherein the same reference numerals have been used to identify the same or similar elements throughout the several views.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure. Examples of various aspects are illustrated and described further below. It will be understood that the description herein is not intended to limit the claims to the specific aspects described. On the contrary, it is intended to cover alternatives, modifications, and equivalents as can be included within the spirit and scope of the present disclosure as defined by the appended claims.

A shape, a size, a ratio, an angle, a number, etc. disclosed in the drawings for describing aspects of the present disclosure are illustrative, and the present disclosure is not limited thereto. The same reference numerals refer to the same elements herein. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure.

The terminology used herein is directed to the purpose of describing particular aspects only and is not intended to be limiting of the present disclosure. As used herein, the singular constitutes “a” and “an” are intended to include the plural constitutes as well, unless the context clearly indicates otherwise. It will be further understood that the terms “comprise”, “including”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements can modify the entire list of elements and may not modify the individual elements of the list. In interpretation of numerical values, an error or tolerance therein can occur even when there is no explicit description thereof.

The present invention can be modified in various forms and have various aspects, and specific aspects thereof are shown by way of example in the drawings and will be described in detail below. It should be understood, however, that there is no intent to limit the present invention to the specific aspects, but on the contrary, the present invention is to cover all modifications, equivalents, and alternatives falling within the spirit and technical scope of the present invention. Like reference numerals refer to like elements throughout the description of the figures.

It will be understood that, although the terms such as first, second, A, B, and the like can be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes combinations of a plurality of associated listed items or any of the plurality of associated listed items.

It will be understood that when an element is referred to as being “coupled” or “connected” to another element, it can be directly coupled or connected to the other element or an intervening element can be present. In contrast, when an element is referred to as being “directly coupled” or “directly connected” to another element, there is no intervening element present.

The terms used herein is for the purpose of describing specific aspects only and are not intended to limit the present invention. As used herein, the singular forms “a”, “an” and “the” are intended to include the plural forms as well, unless the context clearly indicates otherwise. It will be further understood that the terms “comprises”, “comprising”, “includes”, “including” and/or “having”, when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

Unless otherwise defined, all terms used herein, including technical and scientific terms, have the same meanings as commonly understood by one skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Some terms used herein are defined as follows.

A battery cell is a minimum unit that serves to store power and a battery module refers to an assembly in which a plurality of battery cells are electrically connected. A battery cell can also be a component of a battery including an anode and a cathode, and can also include an electrolyte that allows ions to flow between the anode and the cathode via a chemical reaction, as known in the art.

A battery rack refers to a system of a minimum single structure which is assembled by electrically connecting module units, set by a battery manufacturer, and can be monitored and controlled by a battery management apparatus/system (BMS). The BMS can include, as an interface for receiving a measurement value of various parameters described above, a plurality of terminals, a circuit connected to these terminals to perform processing of input values, etc. The BMS connotes a particular device that must include switches, relays, memory and at least one hardware embedded processor for determining which of the battery cells need to be charged/discharged and for executing the charging/discharging operations, as known in the art. A battery rack can include several battery modules and can additionally include a battery protection unit or any other protection device. A battery protection unit (BPU) is known as a safety mechanism that includes overcharge protection, over-discharge protection, short-circuit protection, temperature protection and/or cell balancing, and the BMS can perform the function of a BPU.

A battery bank refers to a group of large-scale battery rack systems configured by connecting several racks in parallel. Alternatively, the battery racks can be connected in series. A bank BMS for a battery bank can monitor and control rack BMSs, each of which manages a battery rack. That is, each battery rack can include a corresponding BMS to control the battery rack, and a bank BMS can control each BMS.

A battery assembly can include a plurality of electrically connected battery cells, and refers to an assembly that functions as a power supply source by being applied to a specific system or device. Here, the battery assembly can be a battery module, a battery pack, a battery rack, or a battery bank, but the scope of the present invention is not limited to these entities.

A battery system controller (BSC) is a top-level control device that controls a battery system including a battery bank or a battery system with a multiple bank level structure.

State of charge (SOC) refers to a current state of charge of a battery, represented in percent points [%], and State of Health (SOH) can be a current condition (e.g., overall health and performance) of a battery compared to its ideal or original conditions, represented in percent points [%]. The SOH can be calculated based on a cycle count (e.g., an number of times the battery has been charged and discharged), a depth of discharge (e.g., the percentage of the battery's capacity that has been discharged each time), storage conditions (e.g., the temperature and humidity at which the battery is stored) and operating conditions (e.g., the voltage and current at which the battery is operated), but is not limited thereto.

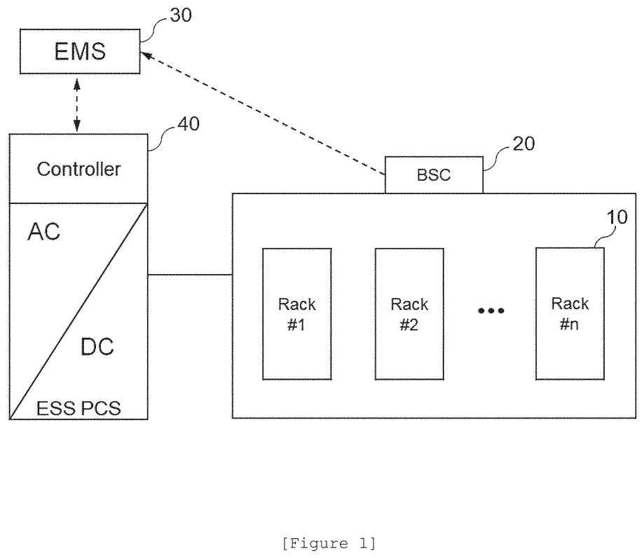

FIG. 1 is a block diagram of a general energy storage system. In an energy storage system (ESS), typically a battery cell is a minimum unit of storing energy or power. A series/parallel combination of battery cells can form a battery module, and a plurality of battery packs can form a battery rack. In other words, a battery rack can be a minimum unit of a battery system as a series/parallel combination of battery packs. Here, depending on a device or a system in which the battery is used, a battery pack can be referred to as a battery module.

Referring to FIG. 1, a battery rack 10 can include a plurality of battery modules and a battery protection unit (BPU) or any other protection device. The battery rack can be monitored and controlled through a rack BMS (RBMS). The RBMS can monitor a current, a voltage and a temperature, among others (e.g., any known battery characteristic), of each battery rack to be managed, calculate a state of charge (SOC) of the battery rack based on monitoring results, and control charging and discharging of the battery rack.

The battery protection unit (BPU) is a device for protecting the battery rack from an abnormal current and/or a fault current in the battery rack. The BPU can include a main contactor (MC), a fuse, and a circuit breaker (CB) or a disconnect switch (DS). The BPU can control a battery system rack by rack through on/off controlling the main contactor (MC) based on a control from the RBMS. The BPU can also protect the battery rack from a short circuit current using a fuse in the event of a short circuit. That is, if a short circuit is detected, the fuse can interrupt the flow of current to the battery rack. As such, the battery system can be controlled through a protection device, such as a BPU or a switchgear (e.g., a circuit breaker, fuse, switch, busbar or the like).

A battery system controller (BSC) 20 can be located in each battery section which includes a plurality of batteries, peripheral circuits, and devices to monitor and control objects (e.g., battery characteristics), such as a voltage, a current, a temperature of the battery, and can include a circuit breaker. The battery system controller is an uppermost control apparatus in a bank level battery system including a plurality of battery racks. The battery system controller can also be used as a control apparatus in a battery system having a plurality of bank level structures.

Furthermore, a power conversion system (PCS) 40 can be installed in each battery section and can perform charging/discharging based on a charge/discharge command (e.g., a charge or discharge command) from the energy management system (EMS) 30. The power conversion system (PCS) 40 can include a power conversion unit (DC/AC inverter), a controller (e.g., a hardware embedded processor) and additionally memory. The output of each BPU can be connected to the PCS 40 through a DC bus, and the PCS 40 can be connected to a power grid. In addition, the EMS (or Power Management System (PMS)) 30 can manage the overall energy storage system (ESS).

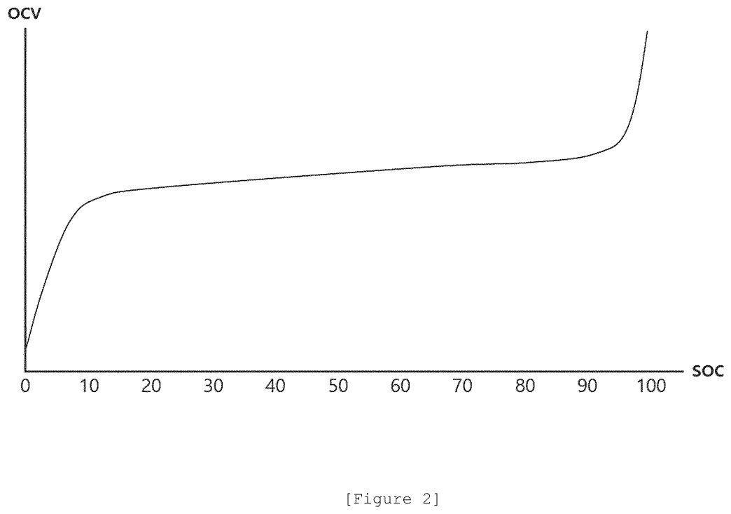

FIG. 2 shows a charging characteristic curve of an LFP battery. More specifically, FIG. 2 shows a charging characteristic curve of a lithium iron phosphate (LFP) battery (e.g., which uses lithium iron phosphate as a cathode active material). The charging characteristic curve represents a correspondence between an open circuit voltage (OCV) and a SOC measured during a battery charging process.

During operation of a battery system, a battery management apparatus can perform balancing control based on SOCs of batteries or can reconnect at least one battery that has been disconnected from the battery system. Here, a method of measuring an open-circuit voltage (OCV) value of the battery and estimating the SOC of the battery based on the measured open-circuit voltage value is mainly used, in order to calculate the SOC of a battery.

Referring to FIG. 2, the charging characteristic curve of the LFP battery has a voltage plateau in the SOC range of about 10% to about 90%. In the case of an LFP battery having such a voltage plateau characteristic, it is difficult to accurately estimate the SOC in the voltage plateau section, accurate estimation is possible only in a non-plateau section (e.g., a section where the SOC is 90% or more, or a section where the SOC is 10% or less). In other words, in a battery system including an LFP battery (or LFP batteries), accurate SOC estimation is possible only in a very limited SOC section.

In FIG. 1, if an abnormality occurs in a specific battery rack among a plurality of battery racks 10 included in a battery system, a parallel connection between the corresponding battery rack and other battery racks can released (e.g., disconnected) and the corresponding battery rack can be disconnected from the battery system. When the abnormal state of the corresponding battery rack is resolved (e.g., by inspection and repair, for instance), the battery rack can be reconnected to the battery system. Here, the corresponding battery rack needs to be reconnected to the battery system when the SOCs of the corresponding battery rack and other battery racks are very similar (e.g., within a threshold SOC difference), for stable operation of the battery system. For instance, the corresponding battery rack must be within a threshold SOC amount from an average SOC among the battery racks.

Here, in the case of battery racks with LFP batteries, battery racks need to be fully charged or fully discharged because accurate estimation of SOC is possible only in non-flat sections (e.g., a section with SOC of 90% or more, or a section with SOC of 10% or less). Thus, it takes a considerable amount of time to reconnect the disconnected battery rack to the battery system.

The present invention is presented to solve this problem and relates to a battery control apparatus and a control method thereof, which minimizes disconnection of an abnormal battery in an exact SOC estimation impossible section thereby stably operating the battery system.

Hereinafter, preferred aspects according to the present invention will be described in detail with reference to the accompanying drawings.

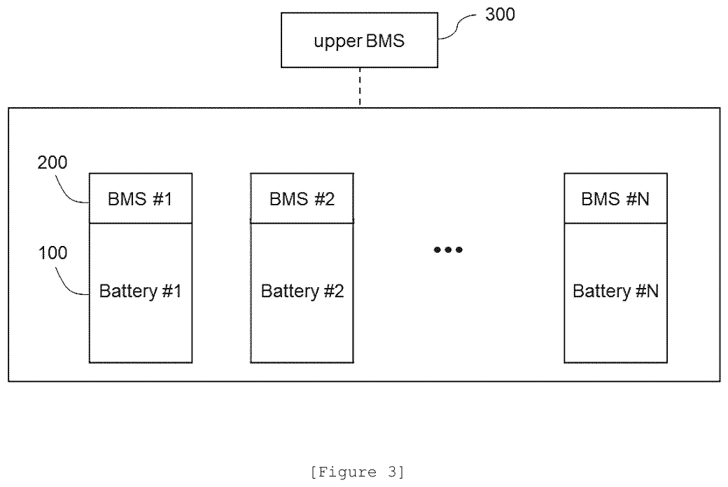

FIG. 3 is a block diagram of a battery system according to aspects of the present invention.

Referring to FIG. 3, the battery system according to aspects of the present invention includes a plurality of batteries 100 and a plurality of battery management systems/apparatuses (BMSs) 200 provided in correspondence to the plurality of batteries, respectively, and for managing and controlling corresponding batteries. The plurality of batteries 100 can be electrically connected to each other in parallel. Alternatively, the plurality of batteries 100 can be electrically connected to each other in series.

In the present disclosure, the battery 100 can be in the form of a battery assembly. In other words, the battery 100 according to the present invention can correspond to a battery module, a battery pack, a battery rack, or a battery bank.

In aspects, the battery 100 can correspond to a battery assembly including one or more battery cells (e.g., LFP battery cells) having at least a portion a voltage profile including a voltage plateau section (e.g., in a charging characteristic curve).

Each BMS 200 can manage and control its corresponding (e.g., respective) battery 100 by collecting state information on the corresponding battery 100 and performing a predefined control operation based on the collected state information. Here, the BMS 200 can control charging and discharging of the battery based on the state information of the battery and diagnose whether the battery cells of the battery are out of order (e.g., non-operational or otherwise defective).

The battery management apparatus 200 can control a switching device provided at an input/output terminal of the battery 100 to release (e.g., disconnect) or reconnect the parallel connection of the battery 100 with other batteries in the battery system.

Each of the plurality of BMSs 200 can be connected to an upper battery management apparatus 300 through a network (e.g., a wireless or wired network), transmit battery state information of the battery to the upper battery management apparatus 300, receive control commands from the upper battery management apparatus 300, and operate based on the received control commands. Here, the upper battery management apparatus 300 can correspond to a battery system controller (BSC), an energy management system (EMS), or a power management system (PMS).

Each of the battery management apparatuses 200 can diagnose whether or not each battery has an abnormality based on state information of a corresponding battery. For example, the battery management apparatus 200 can detect a failure occurrence, such as a short circuit or ignition, based on state information, and the state information can include at least one of a voltage value, a current value, and a temperature value of each battery.

When an abnormal state occurs in a specific battery, the battery management apparatus 200 corresponding to the specific battery can determine whether the SOC of the abnormal battery is within a threshold SOC range predefined as an SOC estimation impossible section. Here, the battery management apparatus 200 can check a voltage value of the battery at the time of detecting the abnormal state of the battery, obtain the SOC corresponding to the checked voltage value through a pre-stored voltage-SOC correlation table, and determine the current SOC of the battery.

The threshold SOC range can be predefined as a section of SOC in which the voltage change relative to SOC change is equal to or less than a predefined threshold value, in a correlation curve depicting a relationship between the SOC and the voltage of the battery. For example, the threshold SOC range can be defined as 5 or more and 95 or less, or 10 or more and 90 or less.

Thereafter, the battery management apparatus 200 can control whether to release (e.g., disconnect) the parallel connection between the specific battery (e.g., the abnormal battery) and other batteries of the battery management apparatus 200 based on whether the SOC of the abnormal battery is within the threshold SOC range.

When the SOC of the abnormal battery is outside of a predefined threshold SOC range, the battery management apparatus 200 can control an input/output switch of the abnormal battery to be in an open state to release the parallel connection with other batteries. In other words, when the abnormal battery is in an SOC estimation possible state, the battery management apparatus 200 can disconnect the abnormal battery from the battery system, can resolve the abnormality by repairing the abnormal battery or replacing the abnormal battery and control to reconnect the replacement or repaired battery to the battery system based on the calculated SOC, when the abnormal state of the battery is resolved.

When the SOC of the abnormal battery is within the predefined threshold SOC range, the battery management apparatus 200 can maintain the parallel connection between the corresponding battery and other batteries. Here, the battery management apparatus 200 can release the parallel connection with other batteries when the corresponding battery becomes out of the threshold SOC range. In other words, when the abnormal battery is in an SOC estimation impossible state, the battery management apparatus 200 may not immediately disconnect the abnormal battery from the battery system, but the battery management apparatus 200 will disconnect the abnormal battery from the battery system when the abnormal battery becomes (e.g., is) in an SOC estimation possible state (e.g., a state in which the SOC of the abnormal battery can be estimated). Accordingly, unnecessary time consumed until the abnormal battery is reconnected to the battery system can be reduced. That is, the time required to reconnect the repaired battery or the replacement battery can be reduced due to the above-recited method for disconnecting the abnormal battery from the battery system.

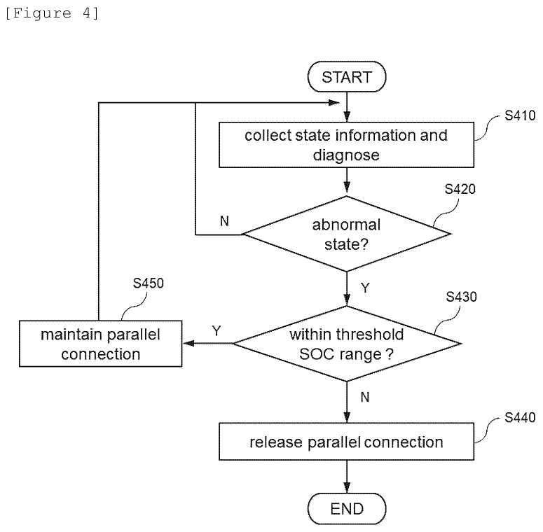

FIG. 4 is an operation flowchart of a control method of the battery management apparatus according to an aspect of the present invention. The control method illustrated in FIG. 4 can be performed in a battery management apparatus that manages and controls a battery connected in parallel with other batteries. Here, the battery management apparatus can correspond to a battery management system (BMS) that directly manages a corresponding battery or can correspond to an upper BMS (e.g., a battery system controller (BSC), an energy management system (EMS), or a power management system (PMS)) of the BMS.

The battery management apparatus can collect state information of the battery and diagnose whether the battery is abnormal based on the collected state information (S410). For example, the battery management apparatus collects state information including one or more of a voltage value, a current value, and a temperature value of the battery, but is not limited thereto, and determines whether or not one or more of the batteries or battery racks of the battery management apparatus is in an abnormal state, including occurrence of a short circuit or ignition, based on the collected state information.

When an abnormal state occurs in the battery (Y in S420), the battery management apparatus can determine whether the SOC of the battery is within a threshold SOC range predefined as an SOC estimation impossible section (S430). Here, the battery management apparatus can control whether to release the parallel connection according to whether the SOC of the battery is within a threshold SOC range.

The threshold SOC range can be predefined as a section of SOC in which the voltage change relative to an SOC change is equal to or less than a predefined threshold value, in a correlation curve depicting a relationship between the SOC and the voltage of the battery. For example, the threshold SOC range can be defined as 5 or more and 95 or less, or 10 or more and 90 or less.

When the SOC of the battery is out of the predetermined threshold SOC range (N in S430), the battery management apparatus can control an input/output switch of the battery to be in an open state to release the parallel connection between the battery and other batteries of the battery system (e.g. disconnect the battery from the battery system to allow for repair or replacement) (S440). In other words, when the abnormal battery is in an SOC estimation possible state, the battery management apparatus 200 can disconnect the abnormal battery from the battery system.

When the SOC of the battery is within a predetermined threshold SOC range (Y in S430), the battery management apparatus can maintain the parallel connection with other batteries (S450).

Thereafter, the battery management apparatus re-determines whether an abnormal state has occurred in the battery (S410, S420), and if the battery is out of the threshold SOC range (N in S430), the battery management apparatus can release the parallel connection with other batteries (S440).

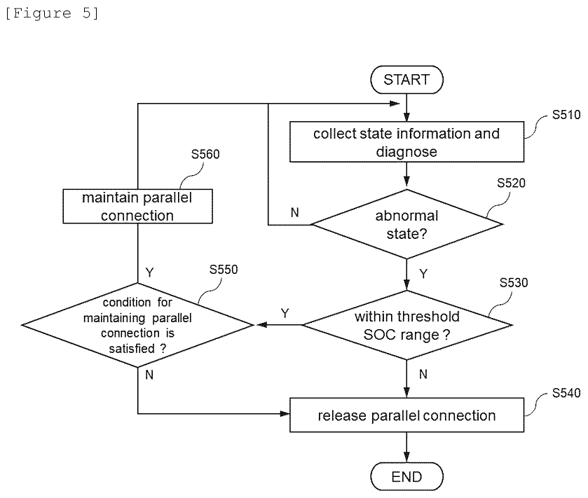

FIG. 5 is an operation flowchart of a control method of the battery management apparatus according to another aspect of the present invention. The control method shown in FIG. 5 is an aspect in which a step of deciding a condition for maintaining a parallel connection is added to the control method shown in FIG. 4.

The battery management apparatus can collect state information of the battery and diagnose whether the battery is abnormal based on the collected state information (S510).

When an abnormal state occurs in the battery (Y in S520), the battery management apparatus can determine whether the SOC of the battery is within a threshold SOC range, predefined as an SOC estimation impossible section, as set forth above (S530).

When the SOC of the battery is out of the predetermined threshold SOC range (N in S530), the battery management apparatus can control an input/output switch of the battery to be in an open state to release the parallel connection with other batteries (S540).

When the SOC of the battery is within the predefined threshold SOC range (Y in S530), that is, the battery is not in an abnormal state, the battery management apparatus can determine whether a predefined condition for maintaining a parallel connection is satisfied (S550). The condition for maintaining the parallel connection can be predefined based on the state information of the battery, and the battery management apparatus can control whether to release the parallel connection depending the determination result. Here, the battery management apparatus can release the parallel connection with other batteries of the battery system (S540) if the condition for maintaining the parallel connection is not satisfied (N in S550). Alternatively, the battery management apparatus can maintain the parallel connection (S560) if the condition for maintaining the parallel connection is satisfied (Y in S550).

The condition for maintaining the parallel connection can include a first condition defined as a state in which a change amount in the cumulative current value of the battery is equal to or less than a predetermined threshold value.

More specifically, when the abnormal battery is within the threshold SOC range (e.g., SOC estimation impossible state), the battery management apparatus can check a cumulative current amount of the battery for a predetermined period. When the change amount of cumulative current of the battery exceeds a predefined threshold (e.g., the first condition is not satisfied), the parallel connection with other batteries can be released. Alternatively, when the change amount of cumulative current of the battery is less than the predefined threshold (e.g., the first condition is satisfied), the parallel connection with other batteries can be maintained.

In other words, even if the battery is in an SOC estimation impossible state (a state within the threshold SOC range) at a time of determining whether an abnormality occurs, the parallel connection of the battery with other batteries of the battery management apparatus can be released as the voltage changes due to the cumulative current (e.g., the first condition not being satisfied) and the SOC estimation becomes possible afterwards.

The condition for maintaining the parallel connection can include a second condition defined as a battery stable state. In an aspect, the second condition can be defined as a state in which a state value including at least one of a temperature value, a current value, and a voltage value of the battery is equal to or less than a predefined threshold value. In another aspect, the second condition can be defined as a state in which a change amount of a state value including at least one of a temperature value, a current value, and a voltage value of the battery is equal to or less than a predefined threshold value.

More specifically, when the abnormal battery is in a state within a threshold SOC range (e.g., SOC estimation impossible state), the battery management apparatus can monitor a state value of the battery for a predetermined period of time. If the state value of the battery exceeds a predefined threshold (e.g., the second condition is not satisfied), the parallel connection with other batteries can be released, whereas if the state value of the battery is equal to or less than a predefined threshold (e.g., the second condition satisfied), the parallel connection with other batteries of the battery management apparatus can be maintained.

In other words, even if the battery is in an SOC estimation impossible state (e.g., a state within the threshold SOC range) at a time of determining whether an abnormality occurs, the parallel connection with other batteries can be released if the battery is in an unstable state (e.g., a dangerous state in which the temperature value exceeds a threshold value), which is the case when the second condition is not satisfied.

In aspects, the battery management apparatus can maintain a parallel connection with other batteries if both the first and the second conditions, included in the condition for maintaining the parallel connection, are satisfied, whereas the battery management apparatus can release the parallel connection with other batteries if either one of the first and the second conditions is not satisfied.

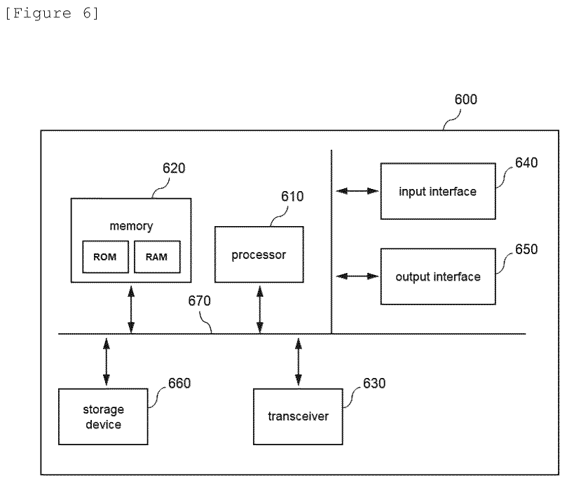

FIG. 6 is a block diagram of a battery management apparatus according to aspects of the present invention.

The battery management apparatus 600 according to aspects of the present invention can correspond to an apparatus located in a battery system, which manages and controls a battery connected in parallel with other batteries. For example, the battery control apparatus 600 can correspond to a rack battery management system (RBMS), a battery system controller (BSC), an energy management system (EMS), or a power management system (PMS), or can be implemented by being included in any one of them.

The battery management apparatus 600 can include at least one processor 610, a memory 620 that stores at least one instruction executed by the processor, and a transceiver 630 connected to a network to perform communication.

The at least one instruction can include an instruction to diagnose whether or not the battery is abnormal based on the state information of the battery, and an instruction to, upon the battery determined to be in an abnormal state, control whether to release the parallel connection between the battery and the one or more other batteries based on whether a state of charge (SOC) of the battery is within a threshold SOC range which is predefined as SOC estimation impossible section.

Here, the threshold SOC range can be predefined as a section of SOC in which the voltage change relative to SOC change is equal to or less than a predefined threshold value, in a correlation curve depicting a relationship between the SOC and the voltage of the battery.

The instruction to control whether to release the parallel connection can include an instruction to release the parallel connection between the battery and the one or more other batteries when the SOC of the battery is out of the threshold SOC range.

The instruction to control whether to release the parallel connection can include: an instruction to, upon the SOC of the battery being within the threshold SOC range, control whether to release the parallel connection between the battery and the one or more other batteries according to whether a condition for maintaining a parallel connection is satisfied, wherein the condition for maintaining a parallel connection is predefined based on the state information of the battery.

The instruction to control whether to release the parallel connection include an instruction to maintain the parallel connection between the battery and the one or more other batteries in the instance that a first condition is satisfied, wherein the first condition is defined as a state in which a change amount of a cumulative current value of the battery is less than or equal to a predefined threshold value.

The instruction to control whether to release the parallel connection include: an instruction to maintain the parallel connection between the battery and the one or more other batteries in the instance that a second condition is satisfied, wherein the second condition is defined as a state in which a state value including at least one of a temperature value, a current value, and a voltage value of the battery is equal to or less than a predefined threshold value, or defined as a state in which a change amount of the state value is equal to or less than a predefined threshold value.

The instruction to control whether to release the parallel connection include an instruction to release the parallel connection between the battery and the one or more other batteries when the condition for maintaining a parallel connection is not satisfied.

The battery management apparatus 600 can further include an input interface 640, an output interface 650, a storage device 660, and the like. Respective components included in the battery control apparatus 600 can be connected by a bus 670 to management with each other.

Here, the processor 610 can be a central processing unit (CPU), a graphics processing unit (GPU), or a dedicated hardware-embedded processor on which methods according to aspects of the present invention are performed. The memory (e.g., storage device) can include at least one of a volatile storage medium and a non-volatile storage medium. For example, the memory can include at least one of read only memory (ROM) and random access memory (RAM).

The operations of the method according to the aspects of the present invention can be implemented as a computer-readable program or code on a computer-readable recording medium. The computer-readable recording medium includes all types of recording devices in which data readable by a computer system is stored. In addition, the computer-readable recording medium can be distributed in a network-connected computer system to store and execute computer-readable programs or codes in a distributed manner.

Although some aspects of the invention have been described in the context of the apparatus, it can also represent a description according to a corresponding method, wherein a block or apparatus corresponds to a method step or feature of a method step. Similarly, aspects described in the context of a method can also represent a feature of a corresponding block or item or a corresponding apparatus. Some or all of the method steps can be performed by (or using) a hardware device, such as, for example, a microprocessor, a programmable computer, or an electronic circuit. In some aspects, one or more of the most important method steps can be performed by such an apparatus.

In the forgoing, the present invention has been described with reference to an aspect of the present invention, but those skilled in the art can appreciate that the present invention can be variously corrected and changed within the range without departing from the spirit and the area of the present invention described in the appending claims.

Various aspects described herein can be implemented in a computer-readable medium using, for example, software, hardware, or some combination thereof. For example, the aspects described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such aspects are implemented by the controller. For Example, the controller is a hardware-embedded processor executing the appropriate algorithms (e.g., flowcharts) for performing the described functions and thus has sufficient structure. Also, the aspects such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

For a software implementation, the aspects such as procedures and functions can be implemented together with separate software modules each of which performs at least one of functions and operations. The software codes can be implemented with a software application written in any suitable programming language. Also, the software codes can be stored in the memory and executed by the controller. Thus, the components shown in the drawings have sufficient structure to implement the appropriate algorithms for performing the described functions.

The present invention encompasses various modifications to each of the examples and aspects discussed herein. According to the invention, one or more features described above in one embodiment (e.g., aspect) or example can be equally applied to another embodiment (e.g., aspect) or example described above. The features of one or more aspects or examples described above can be combined into each of the aspects or examples described above. Any full or partial combination of one or more embodiment or examples of the invention is also part of the invention.

The present invention being thus described, it will be obvious that the same can be varied in many ways. Such variations are not to be regarded as a departure from the spirit and scope of the present invention, and all such modifications as would be obvious to one skilled in the art are intended to be included within the scope of the following claims.

What is claimed:

1. A battery management apparatus for managing and controlling a battery connected in parallel with one or more other batteries, the battery management apparatus comprising:
at least one processor; and
a memory configured to store at least one instruction executed by the at least one processor,
wherein the at least one instruction includes:
an instruction to diagnose whether or not the battery is abnormal based on the state information of the battery; and
an instruction to, upon determining the battery to be in an abnormal state, control whether to release the parallel connection between the battery and the one or more other batteries based on whether a state of charge (SOC) of the battery is within a threshold SOC range, the threshold SOC range being predefined as SOC estimation impossible section.

2. The battery management apparatus of claim 1, wherein the SOC estimation impossible section includes a voltage change relative to SOC change being equal to or less than a predefined threshold value, in a correlation curve depicting a relationship between the SOC and a voltage of the battery.

3. The battery management apparatus of claim 1, wherein the instruction to control whether to release the parallel connection includes:
an instruction to release the parallel connection between the battery and the one or more other batteries when the SOC of the battery is outside of the threshold SOC range.

4. The battery management apparatus of claim 1, wherein the instruction to control whether to release the parallel connection includes:
an instruction to, upon the SOC of the battery being within the threshold SOC range, control whether to release the parallel connection between the battery and the one or more other batteries according to whether a condition for maintaining a parallel connection is satisfied, wherein the condition for maintaining the parallel connection is predefined based on the state information of the battery.

5. The battery management apparatus of claim 4, wherein the instruction to control whether to release the parallel connection further includes:
an instruction to maintain the parallel connection between the battery and the one or more other batteries in the instance that a first condition is satisfied, wherein the first condition is defined as a state in which a change amount of a cumulative current value of the battery is less than or equal to a predefined threshold value.

6. The battery management apparatus of claim 4, wherein the instruction to control whether to release the parallel connection further includes:
an instruction to maintain the parallel connection between the battery and the one or more other batteries in the instance that a second condition is satisfied, wherein the second condition is defined as a state in which a state value including at least one of a temperature value of the battery, a current value of the battery, and a voltage value of the battery is equal to or less than a predefined threshold value, or defined as a state in which a change amount of the state value is equal to or less than a predefined threshold value.

7. The battery management apparatus of claim 4, wherein the instruction to control whether to release the parallel connection further includes:
an instruction to release the parallel connection between the battery and the one or more other batteries when the condition for maintaining the parallel connection is not satisfied.

8. A method performed by a battery control apparatus that manages and controls a battery connected in parallel with one or more other batteries, the method comprising:
diagnosing whether or not the battery is abnormal based on state information of the battery; and
upon determining the battery to be in an abnormal state, controlling whether to release the parallel connection between the battery and the one or more other batteries based on whether a state of charge (SOC) of the battery is within a threshold SOC range, the threshold SOC range being predefined as SOC estimation impossible section.

9. The method of claim 8, wherein the threshold SOC range is predefined as a section of SOC, in which a voltage change relative to SOC change is equal to or less than a predefined threshold value, in a correlation curve depicting a relationship between the SOC and a voltage of the battery.

10. The method of claim 8, wherein the controlling whether to release the parallel connection further includes releasing the parallel connection between the battery and the one or more other batteries when the SOC of the battery is outside of the threshold SOC range.

11. The method of claim 8, wherein the controlling whether to release the parallel connection further includes:
upon the SOC of the battery being within the threshold SOC range, controlling whether to release the parallel connection between the battery and the one or more other batteries according to whether a condition for maintaining the parallel connection is satisfied, wherein the condition for maintaining the parallel connection is predefined based on the state information of the battery.

12. The method of claim 11, wherein the controlling whether to release the parallel connection further includes:
maintaining the parallel connection between the battery and the one or more other batteries in the instance that a first condition is satisfied, wherein the first condition is defined as a state in which a change amount of a cumulative current value of the battery is less than or equal to a predefined threshold value.

13. The method of claim 11, wherein the controlling whether to release the parallel connection further includes:
maintaining the parallel connection between the battery and the one or more other batteries in the instance that a second condition is satisfied, wherein the second condition is defined as a state in which a state value including at least one of a temperature value of the battery, a current value of the battery, and a voltage value of the battery is equal to or less than a predefined threshold value, or defined as a state in which a change amount of the state value is equal to or less than a predefined threshold value.

14. The method of claim 11, wherein the controlling whether to release the parallel connection further includes:
releasing the parallel connection between the battery and the one or more other batteries when the condition for maintaining the parallel connection is not satisfied.

15. A battery system comprising:
a plurality of batteries connected in parallel; and
a plurality of battery management apparatus, each battery management apparatus being configured to manage and control a respective battery among the plurality of batteries,
wherein each battery management apparatus is configured to diagnose whether or not the respective battery is abnormal based on the state information of the respective battery and to control whether to release the parallel connection between the respective battery and one or more other batteries among the plurality of batteries based on whether a state of charge (SOC) of the respective battery is within a threshold SOC range, the threshold SOC being predefined as SOC estimation impossible section.

16. The battery system of claim 15, wherein the threshold SOC range is predefined as a section of SOC, in which a voltage change relative to SOC change is equal to or less than a predefined threshold value, in a correlation curve depicting a relationship between the SOC and the voltage of the respective battery.

17. The battery system of claim 15, wherein each battery management apparatus is further configured to release the parallel connection between the respective battery and the one or more other batteries when the SOC of the respective battery is out of the threshold SOC range.

18. The battery system of claim 15, wherein each battery management apparatus is further configured to, upon the SOC of the respective battery being within the threshold SOC range, control whether to release the parallel connection between the respective battery and the other batteries according to whether a condition for maintaining the parallel connection is satisfied, wherein the condition for maintaining the parallel connection is predefined based on the state information of the respective battery.

19. The battery system of claim 18, wherein each battery management apparatus is further configured to maintain the parallel connection between the respective battery and the other batteries in the instance that a first condition is satisfied, wherein the first condition is defined as a state in which a change amount of a cumulative current value of the respective battery is less than or equal to a predefined threshold value.

20. The battery system of claim 18, wherein each battery management apparatus is further configured to maintain the parallel connection between the respective battery and the one or more other batteries in the instance that a second condition is satisfied, wherein the second condition is defined as a state in which a state value including at least one of a temperature value of the respective battery, a current value of the respective battery, and a voltage value of the respective battery is equal to or less than a predefined threshold value, or defined as a state in which a change amount of the state value is equal to or less than a predefined threshold value.

21. The battery system of claim 18, wherein each battery management apparatus is further configured to release the parallel connection between the respective battery and the other batteries when the condition for maintaining the parallel connection is not satisfied.

22. A battery system comprising:
a battery including a cathode active material having lithium iron phosphate (LiFePO4); and
a battery management apparatus configured to:
manage and control the battery, and
diagnose whether or not the battery is abnormal based on the state information of the battery, the state information of the battery including at least one of a voltage of the battery, a current of the battery, and a temperature of the battery, whether or not the battery is in a state of charge (SOC) estimation impossible section in which the battery exhibits an open circuit voltage (OCV) plateau section.

23. The battery system of claim 22, wherein the battery can comprise a battery module, a battery pack, a battery rack, or a battery bank.
